(19) United States
(12) Patent Application Publication
(10) Pub. No.: US 2001/0053036 A1
(43) Pub. Date: Dec. 20, 2001

(54) SINGLE ENDED PREAMPLIFIER HAVING IMPROVED NOISE CHARACTERESTICS

(76) Inventor: JAMES NODAR, DALLAS, TX (US)

Correspondence Address: TEXAS INSTRUMENTS INCORPORATED, P O BOX 655474, M/S 3999, DALLAS, TX, 75265

(21) Appl. No.: 09/268,462

(22) Filed: Mar. 16, 1999

Related U.S. Application Data
(60) Provisional application No. 60/080,987, filed on Apr. 7, 1998.

(51) Int. Cl. G11B 5/09

(52) U.S. Cl. 360/46

(57) ABSTRACT

A single ended differential input amplifier is used as the initial amplification stage of a preamplifier used in the read channel of a hard disk drive (HDD) application. Over the usable bandwidth of the read channel (typically between about 1 to 100 megahertz), prior art single ended differential input amplifiers are susceptible to noise coupling from the power supply. The invention enhances the power supply noise rejection (PSR) ability of single ended differential input amplifiers by adding a resistor in series with the capacitor that is usually coupled across one leg of the differential amplifier. As the frequencies across the usable bandwidth increase and the capacitor tends to short, the added resistor is effective to maintain impedance without affecting the gain of the amplifier.

### FIELD OF THE INVENTION

The invention relates generally to the field of information storage, more specifically to hard disk drives and in particular to preamplifier circuits.

### BACKGROUND OF THE INVENTION

U.S. Pat. No. 5,831,888 entitled “Automatic Gain Control Circuit” and assigned to Texas Instruments Incorporated, the assignee of the present invention, sets forth generally the description of disk storage. Hard disk drives (HDD) are one type of disk storage that are particularly used in personal computers today. The HDD device generally includes a magnetic storage media, such as rotating disks or platters, a spindle motor, read/write heads, an actuator, a preamplifier, a read channel, a write channel, a servocontroller, a memory and control circuitry to control the operation of the HDD and to properly interface the HDD to a host or system bus. The following U.S. Patents describe various aspects of HDD devices:

| | | |
|---|---|---|
| 5,535,067 | Frequency Controlled Reference Generator | Issued 07/09/96 |
| 5,570,241 | Single Channel, Multiple Head Servo | 10/29/96 |
| 5,862,005 | Synchronous Detection Of Wide BI-Phase | 01/19/99 |
| 5,793,559 | In Drive Correction Of Servo Pattern | 08/11/98 |
| 5,719,719 | Magnetic Disk Drive With Sensing | 02/17/98 |
| 5,444,583 | Disk Drive Having On-Board Triggered | 08/22/95 |
| 5,448,433 | Disk Drive Information Storage Device | 09/05/95 |
| 5,208,556 | Phase Lock Loop For Sector Servo System | 05/04/93 |
| 5,642,244 | Method and Apparatus For Switching | 06/24/97 |

Prior art FIG. 1 illustrates a disk/head assembly 12 and a preamplifier 14. The preamplifier 14 handles both read functions and write functions. Not illustrated in FIG. 1, for clairty, is the Magentoresistive (MR) head. The unshown MR head works through magnetic media and it has both functions, read and write, with a different portion of the head performing each function. The write function portion of the MR head is inductive and the read function portion of the head acts as a magnetic resistive element. A write occurs through an inductive element to the magnetic media disk assembly 12 and a read occurs by sensing the magnetic shifts in the disk assembly 12 by using the resistive read element.

Prior art FIG. 2 illustrates a portion of the read channel of preamplifier 14 of FIG. 1. The resistive portion of the unshown MR head is represented by the resistor Rmr on disk 12. An initial amplification stage 18 of preamplifier 14 connects to the resistive portion Rmr of the MR head. Later gain stages 20 of preamplifier 14 are connected to the outputs of initial amplification stage 18 at nodes A and B. The read path outputs flow from the later gain stages 20. The read channel inputs flow into preamplifier 14 from an unillustrated head select logic stage. In typical mass storage devices of the HDD type, the preamplifier 14 may have as many as 4 or 8 channels. Transistors Sw0 . . . Swn represent the read channel input enabling transistors for N channels.

The architecture of initial amplification stage 18 of preamplifier 14 is constructed as that of a single ended amplifier using only one transistor Qin as opposed to a differential amplifier. (As is known to one of ordinary skill in the art of amplifier design, a differential amplifer uses two transitors to establish the voltages on nodes A and B, one transistor for node A and one transistor on node B.) On one side of the amplifier, the bias current Ib travels through the load resistor R1 and through the collector of transistor Qin to set the voltage on node B. On the other side of the single ended amplifier, the bias current Ib/∝ travels through the scaling resistor ∝R1 to set the voltage on node A. (The reference character ∝ represents the scale factor for the resistor.) In hard disk drives, because of linearity problems during a read operation, the voltage on read head (represented by VRmr) is biased up to a certain level which is typically around 0.2 to 0.5 volts. This bias voltage VRmr is established through a feedback loop created by transconductace amplifier 22 across nodes A and B whose output is connected to the base of transitor Qin. This, in essence, creates a pseudo balanced output on the reader load resistors such as would exist if a differential amplifier were used in the initial amplification stage.

Noise on the power supply is a problem with single ended preamplifier stages during a read operation of a HDD. The power supply is represented by Vcc in prior art FIG. 2. If the value of the resistors R1 and ∝R1 were identical, the voltage at node B (Ib×R1) would be equal to the voltage at node A (Ib/∝×∝R1) and so any noise on the power supply Vcc would be cancelled out. The value of ∝>1 is desirable to save power since the voltage used in ∝R1 is only a reference voltage, hence Ib/∝<Ib. This unfortunately allows noise on the power supply to be coupled from the initial amplification stage into the preamplifier and thus hinders the preamplifiers Power Supply Rejection (PSR) ability. (Those in the HDD industry use PSR as a rating criteria when choosing a manufacturers preamplifier; a better PSR rating is desirable as it reflects increased ability to eliminate noise from the power supply.)

To help control power supply noise, the prior art circuit of FIG. 2 adds a capacitor C2 in parallel with the resistor ∝R1. Such a capacitor C2 will typically be an external capacitor, that is, it will typically be a discrete device and is not processed as part of the semiconductor wafer in the manufacture of preamplifier 14. (Preamplifier 14 is a semiconductor integrated circuit. The resistors R1 and ∝R1 are part of the integrated circuit; the capacitors C1 and C2 are external devices.) The capacitor C2 does not change the transfer function for the serial path of the output read signal; it does not change the gain or bandwidth of the amplifier. It is added to correct stray signal coupling from other sources (such as the power supply) not in the signal path.

The amount of coupling depends upon the frequency of the noise signal. Prior art FIG. 3 is a graph illustrating the amount of noise coupling between the different frequencies of the circuit prior art FIG. 2. In FIG. 3, the value 0 DB means that if a signal having a reference unit amplitude is input into Vcc, a reference unit of amplitude is output by initial amplification stage 18. As the graph shows, any signal with less than zero DB is attenuated and any signal with DB greater than zero is a gain—it is magnified out. As the frequencies increase, the graph crosses 0 DB and moves upward. The desired frequency band for a HDD is from around 1 megahertz to about 100 megahertz as this is the frequency range at which signals are recorded on the disks. As the figure unfortunately shows, however, the graph crosses 0 DB during this frequency range.

It is accordingly an object of this invention to improve the PSR ability of a preamplifer. More noise coupled from the power supply over the desired frequency range needs to be eliminated.

Other objects and advantages of the invention herein will be apparent to those of ordinary skill in the art having the benefit of the description herein.

### SUMMARY OF THE INVENTION

The invention herein increases the ability of a preamplifier to eliminate noise over the desired frequency range of about 1 megahertz to about 100 megahertz in hard disk drive applications. A resistor is added in series with the conventional parallel connected capacitor on one input of the single ended input amplification stage of the preamplifier. The capacitor is effective to hinder noise at the lower frequencies generated by the preamplifier itself. As the frequencies increase and the capacitor tends to short, the resistor is effective to maintain the impedance on the node. The invention thus effectively balances any differences in the resistor levels of the single ended amplification stage to prevent power supply noise coupling over the desired frequency range.

### BRIEF DESCRIPTION OF THE DRAWINGS

FIG. 1 is a prior art drawing illustrating a disk/head assembly and a preamplifier of a typical HDD device.

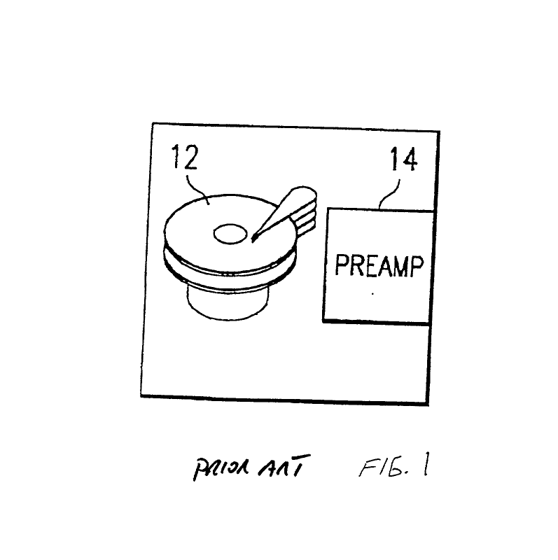

FIG. 2 is a prior art drawing illustrating the initial amplification stage of the preamplifier of FIG. 1.

FIG. 3 is a graph illustrating the noise amplification ability of the initial amplification stage of the preamplifier of FIG. 2.

FIG. 4 is a schematic drawing illustrating the preferred embodiment of the initial amplification stage according to the invention.

FIG. 5 is a graph illustrating the improved noise amplification ability of the initial amplification stage of the preamplifier of FIG. 4

### DETAILED DESCRIPTION OF THE PREFERRED EMBODIMENT OF THE INVENTION

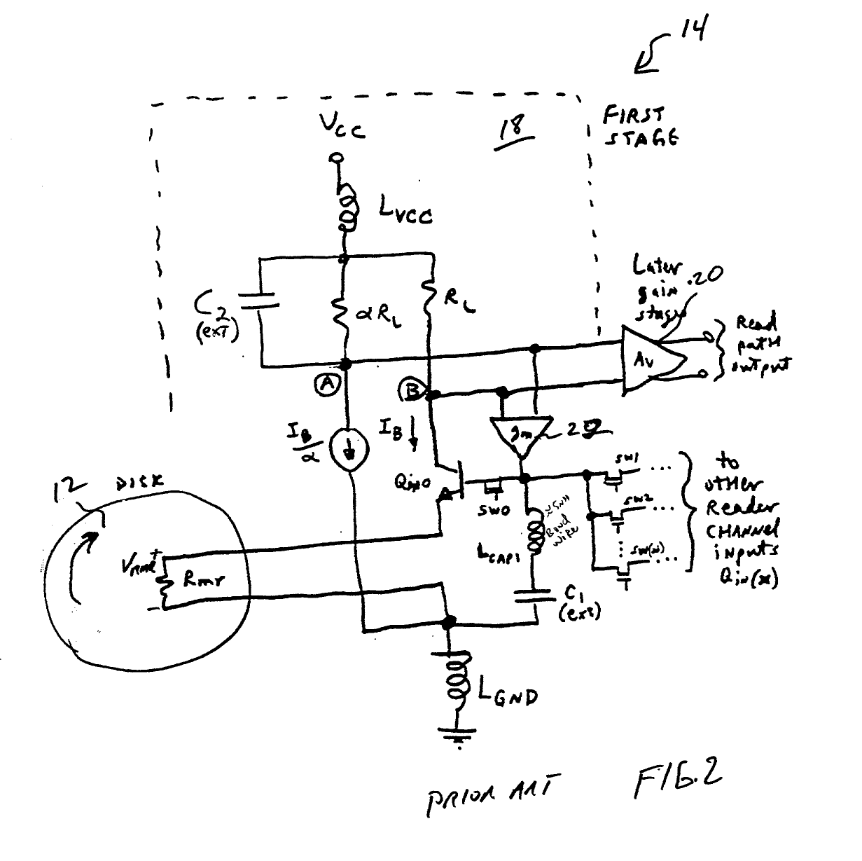

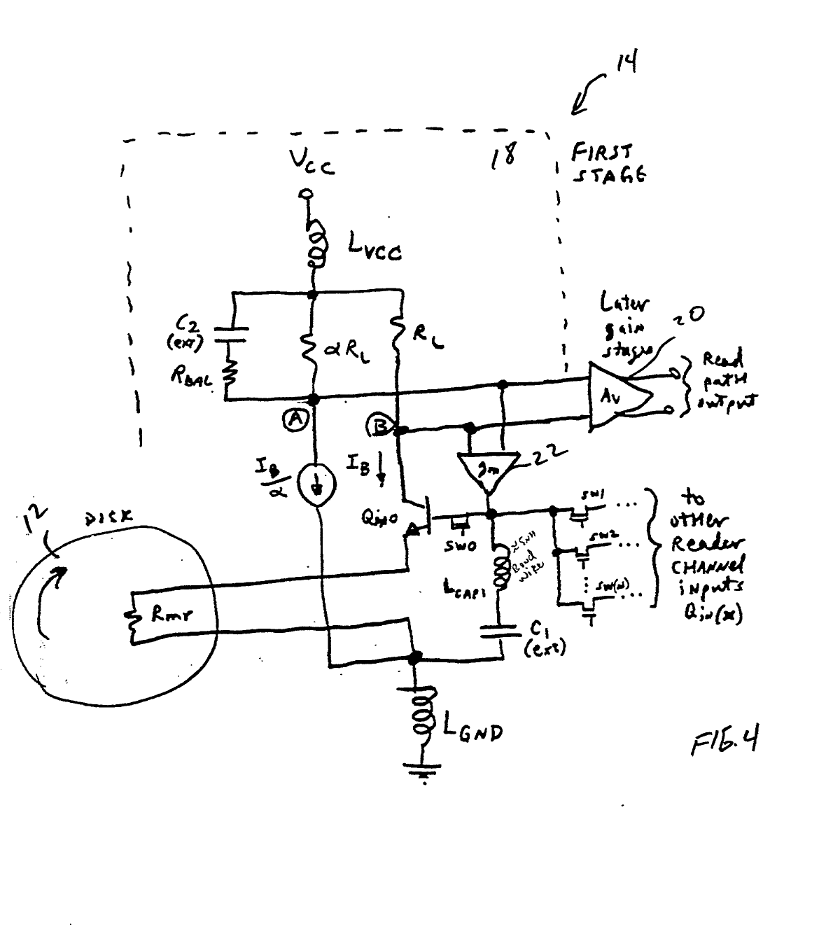

FIG. 4 depicts an electrical schematic of the preferred embodiment of the inventive preamplifier. The invention is readily seen when comparing FIG. 4 to prior art FIG. 2 as FIG. 4 uses the same reference numerals.

In the initial amplification stage 18 of preamplifier 14 of FIG. 4, resistor Rba1 is added. The prior art capacitor C2 and the new resistor Rba1 are connected together in series. They are connected in parallel across resistor ∝R1.

The values of the resistors R1 and ∝R1 and the value of the capacitor C2 are highly dependent upon the characteristics of semiconductor processing recipe used to construct the preamplifier as well as the particular design goals. In the process used by Texas Instruments, the resistor R1 would have a typical value of about 200 ohms. The scaling resistor ∝R1 will typically be around 4 kilohoms. With these values, the capacitor C2 may be around 10 nanofarads. As stated in the Background Of The Invention, the capacitor C2 is typically an external device. However, capacitor C2 need not be an external device and it may be manufactured as an internal device as part of the semiconductor integrated circuit. Such an internal capacitor C2, again with reference to the Texas Instruments manufacturing process, would have a value on the order of about 800 picofarads. The value of the resistor Rba1 selected is equal to one half of R1, as opposed to an equal value of R1, as a trade off between PSR and thermal noise. The resistor Rba1 is preferably manufactured as part of the integrated circuit.

In the process utilized by Texas Instruments, the 10 nanofarad value of external capacitor C2 is enough to filter out just about any amount of noise over the lower frequencies from the current source illustrated in FIG. 4 by Ib/∝. Applying the frequency impedance formula for a capacitor, this value of capacitance is effectively an open circuit at low frequencies and a short circuit at high frequencies. The resistor Rba1 is added in series with capacitor C2 to maintain impedance on node A as the noise frequency increases and the capacitor C2 shorts out. Ideally, only the capacitor C2 would be needed to eliminate the noise; however, because its impedance lessens as the frequency increases over the usable bandwidth, the resistor Rba1 is needed for PSR. The resistor Rba1 does not affect the transfer function of the preamplifier as no signal is delivered to this pseudo-differential reference node since the single ended input is on the Rmr side. Like capacitor C2, it corrects stray signals from other sources (such as the power supply) not in the main signal path.

The read path of a hard disk drive preamplifier is essentially an open loop, high gain, wide bandwidth amplifier. Since it runs open loop, any unintended feedback path can cause oscillation. Such oscillation can occur when PSR exhibits amplification instead of the usual attenuation to the amplifier output, especially when there is resonance involved. The addition of the resistor Rba1 helps balance first stage differential outputs. At high frequencies, the capacitor C2 essentially becomes a short, so the impedance at node A equals Rba1 in parallel with ∝R1, which can be tuned with Rba1 to match or mismatch the impedance at node B, which equals the resistor R1. Sometimes mismatch can produce a suitable result, as in the case of the resistor values shown above, where Rba1 was selected to be about half the size of resistor R1, which helped minimize its noise contribution.

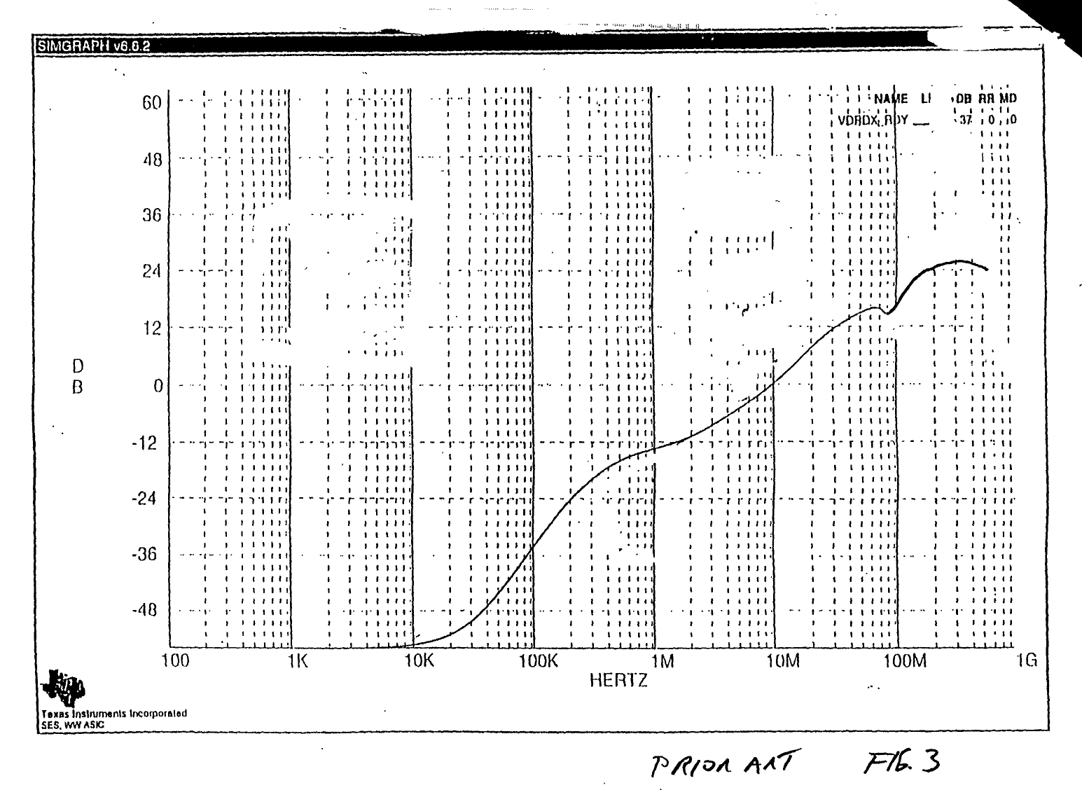

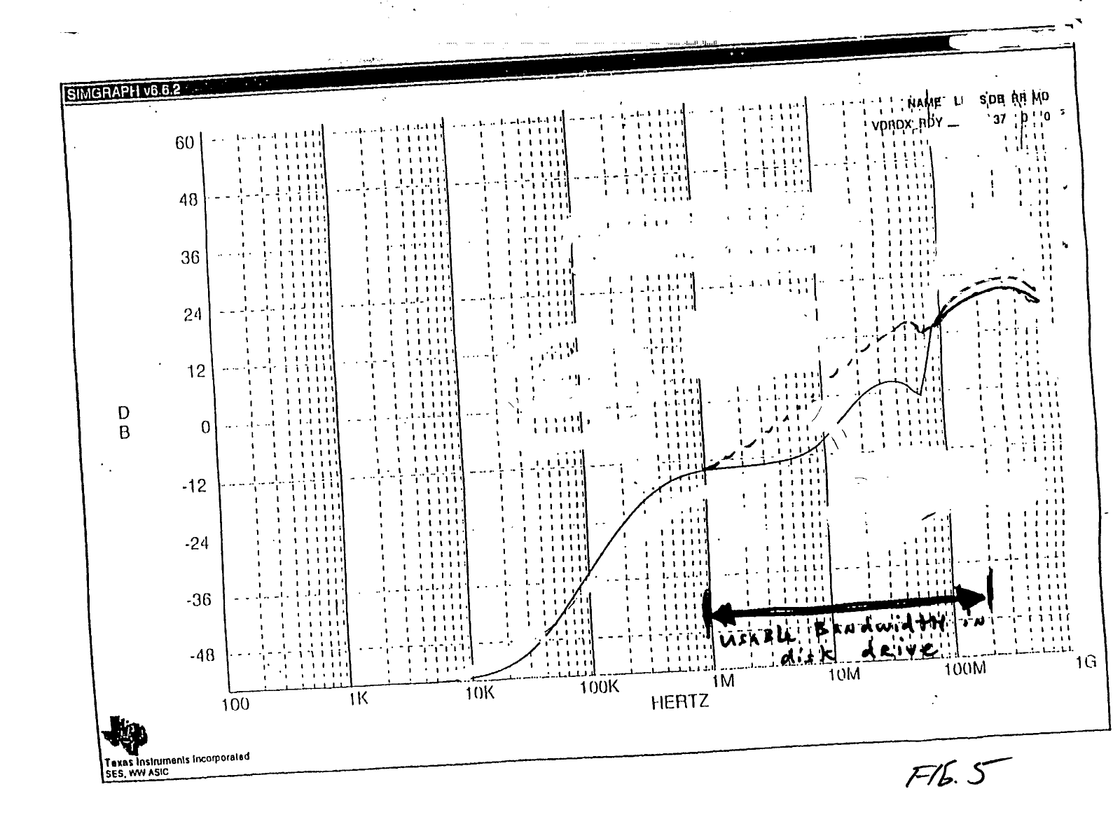

Attention is now directed to FIG. 5 which is a graph illustrating the improved PSR response of the circuit of FIG. 4 as compared to the prior art graph of FIG. 3 that illustrates the PSR response of the prior art circuit of FIG. 2. The dotted line between 1 meghertz and 100 megahertz reflects the prior art FIG. 3 graph. The solid line between this range (the effective useable range for HDD mass storage devices) reflects the substantial improvement of about 10 DB gained by the preferred embodiment of the invention.

While the invention has been particularly shown and described by the foregoing detailed description, it will be understood by those skilled in the art that various other changes in form and detail may be made without departing from the spirit and scope of the invention as defined by the following claims.

What is claimed is:

1. A single ended differential amplifier for a magnetic resistive read head, comprising:
a first node connected to a magnetic resistive head;
a second node;
a transistor having its collector connected to the second node and its emitter connected to magnetic resistive read head;
a load resistor having one end connected to a voltage source and another end connected to the second node;
a scaling resistor having one end connected to the voltage source and another end connected to the first node;
a capacitor having one end connected to the voltage source; and
a balance resistor having one end connected to the capacitor and another end connected to the first node such that the balance resistor and the capacitor are connected in parallel with the scaling resistor.

2. The single ended differential amplifier of claim 1 further comprising:
a transconductance amplifier having one input connected to the first node, one input connected to the second node and having its output connected to the magnetic resistive head.

3. A preamplifier for a hard disk drive, comprising:
a single ended differential input amplifier connected to a magnetic resistive head to read a signal on the magnetic resistive head and form the initial input stage of the preamplifier;
a gain stage connected to the differential input amplifier to amplify the output read signal from the differential input amplifier; and
wherein the single ended differential input amplifier has a resistor and a capacitor that are connected together in series connected to the psuedo differential input leg of the differential amplifier.

4. The preamplifier of claim 3 further comprising:
a transconductance amplifier having one input connected to the psuedo differential input leg of the differential amplifier, another input connected to the other leg of the differential input amplifier and having its output connected to the psuedo differential input leg of the differential amplifier.
